(19) United States
(12) Patent Application Publication
(10) Pub. No.: US 2015/0352735 A1
(43) Pub. Date: Dec. 10, 2015

(54) ELECTRIC HAIR CLIPPER HAVING VISUAL FEEDBACK

(71) Applicants: Michael Matthews, Washington, DC (US); Gregory Harvin, Washington, DC (US)

(72) Inventors: Michael Matthews, Washington, DC (US); Gregory Harvin, Washington, DC (US)

(21) Appl. No.: 14/298,502

(22) Filed: Jun. 6, 2014

(51) Int. Cl. B26B 19/38

(52) U.S. Cl. CPC B26B 19/388; B26B 19/382

(57) ABSTRACT

An electric clipper having a visual feedback system for displaying the running RPMs thereof. The electric clipper having a visual feedback system comprises a base hair clipper which includes an external display screen. The base hair clipper is constructed as conventional electric hair clippers and includes tuner is connected to the base hair clipper's internal motor and enables the operating speed of the motor to be adjusted. An internal tachometer is additionally included in the base hair clipper to generate measurements of the rotation speed of the motor. Such measurements are displayed on the external display, defined as an LED display. The LED display is configured to provide a digital readout of the RPMs of the motor in real time and provide a color coded output corresponding to a general range of RPMs.

### BACKGROUND OF THE INVENTION

1. Field of the Invention

This invention relates generally to grooming devices and, more particularly, to an electric hair clipper having a visual feedback system of the motor's RPM level.

2. Description of the Prior Art

The operation of hair clippers, particularly the use of a pair of sharpened comb-like blades stacked in close contact and which oscillate sideways relative to one another, is well known. Both electric hair clippers and manual hair clippers operate in such a fashion, which electric hair clippers employing a motor to drive the oscillation while manual clippers rely on manual action by the user for the same. A problem which still exists, however, is that when electric hair clippers are used, a user is often unable to determine the speed of the motor at a given moment, complicating the process of determining whether it is necessary to adjust the speed, measured in revolutions per minute (RPM), to the user's desired or preferred setting. Thus, there remains a need for an electric clipper having a visual feedback system which would enable a user to visually determine the present RPMs of the clipper's motor was. It would be helpful if such an electric clipper having a visual feedback system employed a digital display screen which displayed the current RPMs of the motor. It would be additionally desirable for such an electric clipper having a visual feedback system to include a color coded system to enable a user to ascertain various motor speed levels without having to look directly at the display screen.

The Applicant's invention described herein provides for an electric hair clipper adapted to allow include a digital readout of the present motor speed during operation. The primary components in Applicant's electric clipper having a visual feedback system are a modified hair clipper and an LED display screen. When in operation, the electric clipper having a visual feedback system enables a user to visually ascertain its operating RPM level at any given moment. As a result, many of the limitations imposed by prior art structures are removed.

### SUMMARY OF THE INVENTION

An electric clipper having a visual feedback system for displaying the running RPMs thereof. The electric clipper having a visual feedback system comprises a base hair clipper which includes an external display screen. The base hair clipper is constructed as conventional electric hair clippers and includes tuner is connected to the base hair clipper's internal motor and enables the operating speed of the motor to be adjusted.

An internal tachometer is additionally included in the base hair clipper to generate measurements of the rotation speed of the motor. Such measurements are displayed on the external display, defined as an LED display. The LED display is configured to provide a digital readout of the RPMs of the motor in real time and provide a color coded output corresponding to a general range of RPMs. Because of such real time visual feedback of motor speed, the electric clipper having a visual feedback system enables a user to tune the motor precisely to a preferred or desired RPM level for a given task and eliminates the need for the user to approximate or guess while tuning the motor.

It is an object of this invention to provide an electric clipper having a visual feedback system which would enable a user to visually determine the present RPMs of the clipper's motor was.

It is another object of this invention to provide an electric clipper having a visual feedback system which employs a digital display screen which displayed the current RPMs of the motor.

It is yet another object of this invention to provide an electric clipper having a visual feedback system that includes a color coded system to enable a user to ascertain various motor speed levels without having to look directly at the display screen.

These and other objects will be apparent to one of skill in the art.

### BRIEF DESCRIPTION OF THE DRAWINGS

FIG. 1 is a side perspective view of an electric clipper having a visual feedback system built in accordance with the present invention.

FIG. 2a is a front elevational view of the reference bar of an electric clipper having a visual feedback system built in accordance with the present invention showing low RPMs.

FIG. 2b is a front elevational view of the reference bar of an electric clipper having a visual feedback system built in accordance with the present invention showing moderate RPMs.

FIG. 2c is a front elevational view of the reference bar of an electric clipper having a visual feedback system built in accordance with the present invention showing high RPMs.

FIG. 2d is a front elevational view of the reference bar of an electric clipper having a visual feedback system built in accordance with the present invention showing very high RPMs.

### DETAILED DESCRIPTION OF THE INVENTION

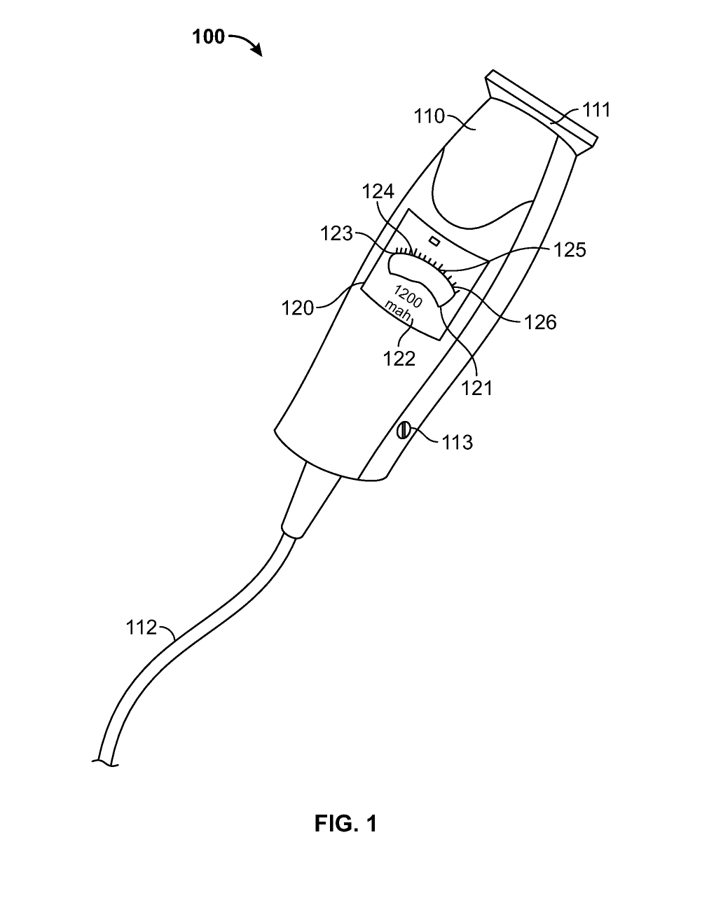

Referring now to the drawings and in particular FIG. 1, an electric clipper having a visual feedback system 100 is shown having a base hair clipper 110 which includes a display screen 120. The base hair clipper 110 is constructed as conventional electric hair clippers. As such, the base hair clipper 110 includes a blade section 111, a cord section 112, and a tuner 113, all of which operate as conventional electric hair clipper components. Accordingly, the tuner 113 is connected to the base hair clipper's 110 internal motor and enables the operating speed of the motor to be adjusted.

Also connected to the base hair clipper's 110 motor is an internal tachometer to measure the rotation speed of the motor. The tachometer is electrically connected to the display screen 120 to enable the display screen to display the output of the tachometer. In this regard, the visual feedback system of the electric clipper having a visual feedback system 100 is defined by the tachometer's measurements of the rotation speed of the motor being provided to the display screen 120 where they can be visually displayed.

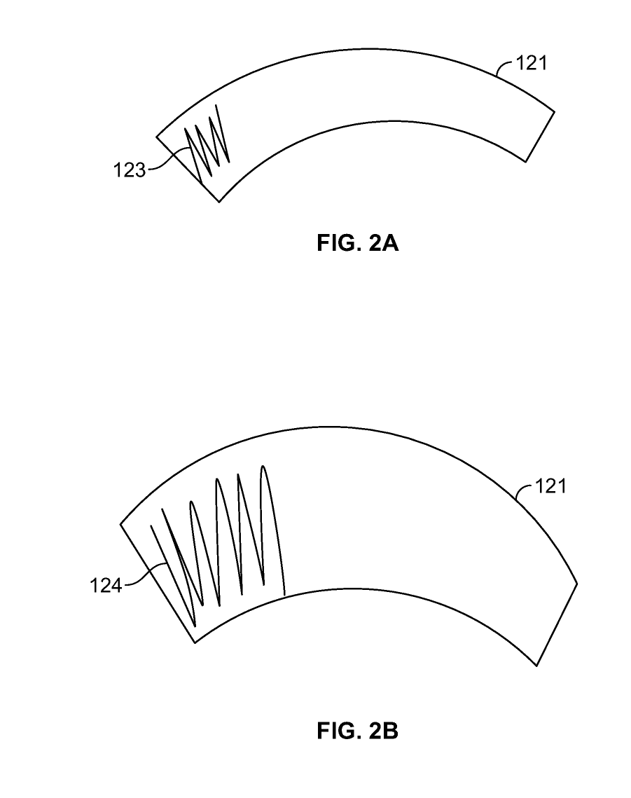

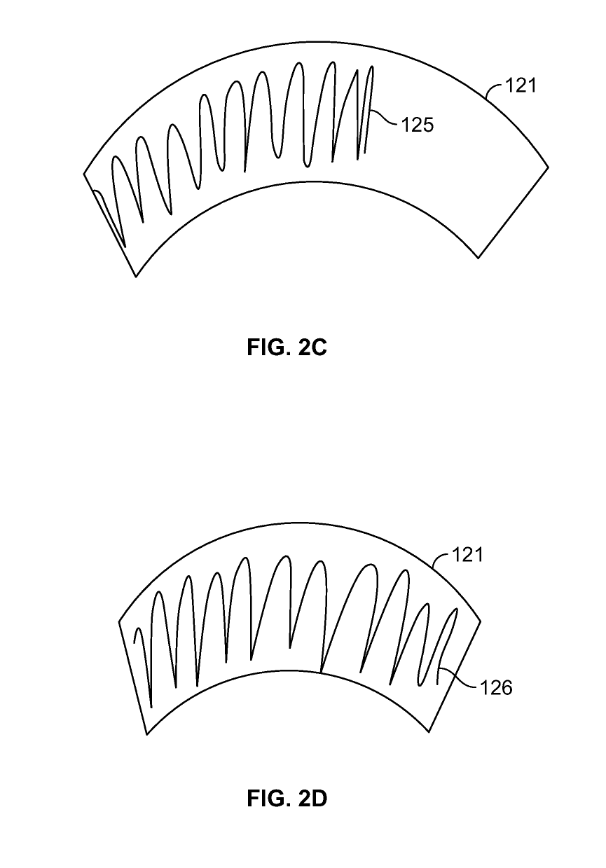

Referring now to FIGS. 1, 2a, 2b, and 2c, in the preferred embodiment, the display screen 120 is defined as an LED screen having a reference bar 121 and a digital RPM readout 122. When in operation, the digital RPM readout 122 displays a numeric value representing the real time RPMs of the motor, while the reference bar 121 progressively fills from left to right as the RPMs of the motor increase in a similar manner to a digital instrument meter with analogue display. When the RPMs of the base hair clipper's 110 motor are low, below 600 in the preferred embodiment, the reference bar 121 fills a corresponding low amount 123 and the filling and the digital RPM readout 122 is colored green. When the RPMs of the base hair clipper's 110 motor are moderate, between 600 and 1000 in the preferred embodiment, the reference bar 121 fills a corresponding moderate amount 124 and the entire filling, plus the digital RPM readout 122, changes to red. When the RPMs of the base hair clipper's 110 motor are high, between 1001 and 1500 in the preferred embodiment, the reference bar 121 fills a corresponding high amount 125 and the entire filling, plus the digital RPM readout 122, changes to orange. And when the RPMs of the base hair clipper's 110 motor are very high, between 1501 and 2000 in the preferred embodiment, the reference bar 121 fills a corresponding very high amount 126 and the entire filling, plus the digital RPM readout 122, changes to blue.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. An electric clipper having a visual feedback system, comprising:
a base hair clipper having an outer casing and a motor, wherein said base hair clipper includes a display screen disposed on said outer casing; and
wherein said display screen is configured to display the RPMs of the motor in real time.

2. The electric clipper having a visual feedback system of claim 1, wherein said base hair clipper includes a tachometer connected to said motor and to said display screen.

3. The electric clipper having a visual feedback system of claim 1, wherein said display screen includes two discrete visual outputs representing the RPMs of the motor.

4. The electric clipper having a visual feedback system of claim 1, wherein the output of the display screen includes illumination from a plurality of LEDs.

5. The electric clipper having a visual feedback system of claim 4, wherein the display screen includes a digital readout and a progressively filling reference bar.

6. The electric clipper having a visual feedback system of claim 4, wherein at least two discrete ranges of RPMs are defined on the display screen.

7. The electric clipper having a visual feedback system of claim 6, wherein the color of the digital readout and progressively filling reference bar is determined by the current measurement of RPMs of the motor relative to defined ranges.

8. The electric clipper having a visual feedback system of claim 6, wherein four discrete ranges of RPMs are defined on the display screen.
